(19) United States
(12) Patent Application Publication
(10) Pub. No.: US 2024/0411197 A1
(43) Pub. Date: Dec. 12, 2024

(54) ORNAMENT WITH ELECTRONIC INK SCREEN

(71) Applicant: Haiqi Wang, Shenzhen (CN)

(72) Inventor: Haiqi Wang, Shenzhen (CN)

(21) Appl. No.: 18/807,934

(22) Filed: Aug. 17, 2024

(30) Foreign Application Priority Data
Aug. 12, 2024 (CN) 202421953708.4

(51) Int. Cl. G02F 1/16753; A44C 25/00; G09G 3/34

(52) U.S. Cl. CPC G02F 1/16753; G09G 3/344; A44C 25/001; G09G 2370/16

(57) ABSTRACT

The present disclosure relates to the technical field of ornaments, specifically to an ornament with an electronic ink screen. The ornament includes a fixed frame and an ink screen body; the ink screen body is arranged in the fixed frame; fixing holes are provided in the fixed frame and the ink screen body; and a fixing member is arranged in the fixing hole. To use the device, the device can be turned on only after the ink screen body is turned on by a Bluetooth module, so that the ink screen body can be continuously in a dormant shutdown state to effectively reduce the energy consumption of the device; and furthermore, the ink screen body can be controlled through a mobile phone APP or a Bluetooth system, thereby adjusting a pattern effect displayed by the ink screen body to meet a need of a customer.

### TECHNICAL FIELD

The present disclosure relates to the technical field of ornaments, and in particular, to an ornament with an electronic ink screen.

### BACKGROUND

To display a picture, a pattern, characters, letters, numbers, and the like on a surface of a traditional ornament, a user needs to provide the content (including the picture, the pattern, the characters, the letters, the numbers, and the like) to a seller of the traditional ornament. The seller prints the content provided by the user on a surface of the ornament through color printing, laser engraving, and another way. In this way, the content on the ornament is customized at once and cannot be changed. With the increasing demand for personalized customization at present, there is a need for a new way to customize content on an ornament, and users can change the content on their own. This brings the users a new experience and meets their needs for personalized customization of content. Ornaments are mainly used in credit card bags, bank card bags, phone card bags, pet cards, pendant necklaces, gift boxes, and other fields.

### SUMMARY

The present disclosure aims to provide an ornament with an electronic ink screen, to solve the problems in the above background section.

An ornament with an electronic ink screen includes a fixed frame and an ink screen body, wherein the ink screen body is arranged in the fixed frame; a fixing hole is provided in the fixed frame and the ink screen body; and a fixing member is arranged in the fixing hole.

Preferably, the fixed frame is connected to the ink screen body through glue.

The fixed frame and the ink screen body can be connected not only by the glue, but also by embedding, clamping, and another way. The fixed frame can protect the ink screen body and avoid damage to the ink screen body.

Preferably, a control device and a button cell are arranged in the fixed frame, and the control device is connected to the ink screen body.

Preferably, the control device includes a Bluetooth module and a switch; the Bluetooth module is connected to the switch; and the Bluetooth module and the switch are respectively connected to the ink screen body.

A control chip is arranged in the Bluetooth module, so the Bluetooth module can control the switch to be turned on and turned off, to control the ink screen body to be turned on and turned off. When the ink screen body is in an ON state, the Bluetooth module is transmitted and controlled through a mobile phone APP, so as to control an image on a surface of the ink screen body, thereby achieving the effect of changing the image decoration.

The Bluetooth module is powered by the button cell. The ink screen body only needs be powered when the switch is turned on, thereby effectively reducing the power consumption of the device.

Preferably, the fixing member is provided with an iron ring and a connecting rope.

The shape of the fixing member can be changed according to a need, so that the fixed frame can be connected to an external object such as a wallet, a keychain, a cup, and a pet collar through the fixing member, thereby decorating the external object.

Beneficial effects of the present disclosure are as follows:

1. The device is mainly used in credit card bags, bank card bags, phone card bags, pet cards, pendant necklaces, gift boxes, and other fields. The device is connected to an external object to decorate the external object. To use the device, the device can be turned on only after the ink screen body is turned on by the Bluetooth module, so that the ink screen body can be continuously in a dormant shutdown state to effectively reduce the energy consumption of the device; and furthermore, the ink screen body can be controlled through a mobile phone APP or a Bluetooth system, thereby adjusting a pattern effect displayed by the ink screen body to meet a need of a customer.

### BRIEF DESCRIPTION OF THE DRAWINGS

The accompanying drawings are intended to provide a further understanding of the present disclosure and constitute a part of this specification. The accompanying drawings and the embodiments of the present disclosure are used together for explaining the present disclosure rather than constituting a limitation on the present disclosure. In the drawings:

FIG. 1 is a schematic structural diagram of an entire front view of the present disclosure; and

FIG. 2 is a schematic diagram of circuit control of an ink screen body.

In the drawings: 1: fixed frame; 2: ink screen body; 3: fixing hole; and 4: fixing member.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

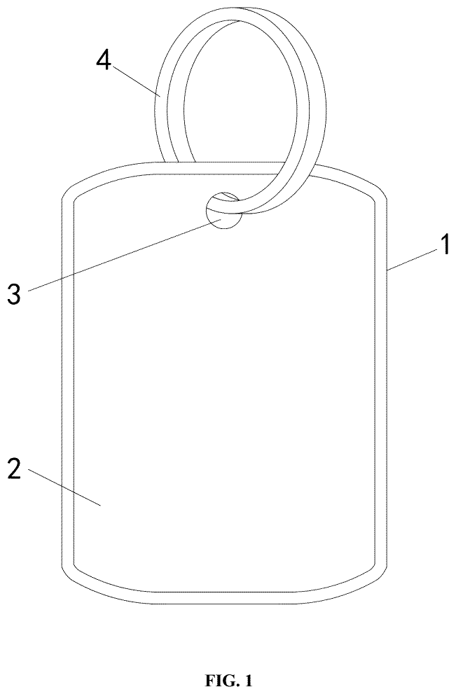

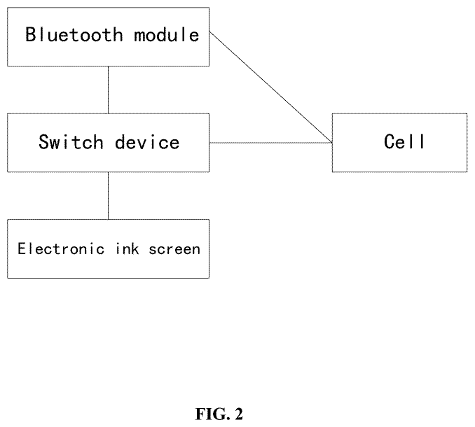

In specific implementation, as shown in FIG. 1 and FIG. 2, an ornament with an electronic ink screen includes a fixed frame 1 and an ink screen body 2. The ink screen body 2 is arranged in the fixed frame 1; a fixing hole 3 is provided in the fixed frame 1 and the ink screen body 2; and a fixing member 4 is arranged in the fixing hole 3.

The fixed frame 1 is connected to the ink screen body 2 through glue.

The fixed frame 1 and the ink screen body 2 can be connected not only by the glue, but also by embedding, clamping, and another way. The fixed frame 1 can protect the ink screen body 2 and avoid damage to the ink screen body 2.

A control device and a button cell are arranged in the fixed frame 1, and the control device is connected to the ink screen body 2.

The control device includes a Bluetooth module and a switch; the Bluetooth module is connected to the switch; and the Bluetooth module and the switch are respectively connected to the ink screen body 2.

A control chip is arranged in the Bluetooth module, so the Bluetooth module can control the switch to be turned on and turned off, to control the ink screen body 2 to be turned on and turned off. When the ink screen body 2 is in an ON state, the Bluetooth module is transmitted and controlled through a mobile phone APP, so as to control an image on a surface of the ink screen body 2, thereby achieving the effect of changing the image decoration.

The Bluetooth module is powered by the button cell. The ink screen body 2 only needs be powered when the switch is turned on, thereby effectively reducing the power consumption of the device.

The fixing member 4 is provided with an iron ring and a connecting rope.

The shape of the fixing member 4 can be changed according to a need, so that the fixed frame 1 can be connected to an external object such as a wallet, a keychain, a cup, and a pet collar through the fixing member 4, thereby decorating the external object.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

It should be finally noted that: The foregoing embodiments are merely preferred embodiments of the present disclosure, but not intended to limit the present disclosure. Although the present disclosure is described in detail with reference to the foregoing embodiments, a person of ordinary skill in the art may still make modifications to the technical solutions described in the foregoing respective embodiments or make equivalent replacements to partial technical features thereof. Any modification, equivalent replacement, and improvement made within the spirit and scope of the present disclosure shall fall within the protection scope of the present disclosure.

What is claimed is:

1. An ornament with an electronic ink screen, comprising a fixed frame (1) and an ink screen body (2), wherein the ink screen body (2) is arranged in the fixed frame (1); a fixing hole (3) is provided in the fixed frame (1) and the ink screen body (2); and a fixing member (4) is arranged in the fixing hole (3).

2. The ornament with the electronic ink screen according to claim 1, wherein the fixed frame (1) is connected to the ink screen body (2) through glue.

3. The ornament with the electronic ink screen according to claim 1, wherein a control device and a button cell are arranged in the fixed frame (1), and the control device is connected to the ink screen body (2).

4. The ornament with the electronic ink screen according to claim 3, wherein the control device comprises a Bluetooth module and a switch; the Bluetooth module is connected to the switch; and the Bluetooth module and the switch are respectively connected to the ink screen body (2).

5. The ornament with the electronic ink screen according to claim 1, wherein the fixing member (4) is provided with an iron ring and a connecting rope.
